(19) United States
(12) Patent Application Publication
(10) Pub. No.: US 2023/0192084 A1
(43) Pub. Date: Jun. 22, 2023

(54) AUTONOMOUS VEHICLE, CONTROL SYSTEM FOR SHARING INFORMATION WITH AUTONOMOUS VEHICLE, AND METHOD THEREOF

(71) Applicants: HYUNDAI MOTOR COMPANY, Seoul (KR); Kia Corporation, Seoul (KR)

(72) Inventors: Eun Young CHOI, Seoul (KR); Woo Jin KIM, Incheon (KR); Min Sang YU, Hwaseong-si (KR); Rosali Sun PYUN, Seongnam-si (KR); Ki Seok SEONG, Cheonan-si (KR); Dong Il YANG, Seoul (KR); Seo Hyung CHEON, Seongnam-si (KR)

(73) Assignees: HYUNDAI MOTOR COMPANY, Seoul (KR); Kia Corporation, Seoul (KR)

(21) Appl. No.: 17/837,555

(22) Filed: Jun. 10, 2022

(30) Foreign Application Priority Data
Dec. 20, 2021 (KR) 10-2021-0182764

(51) Int. Cl. B60W 30/16; B60W 30/18; B60W 30/095; B60W 40/04; B60W 60/00; G06F 21/62; G06V 20/62; G06V 20/58

(52) U.S. Cl. CPC B60W 30/16; B60W 30/18163; B60W 30/0956; B60W 40/04; B60W 60/0011; B60W 60/0015; G06F 21/6245; G06V 20/625; G06V 20/58; B60W 2420/42; B60W 2554/4041; B60W 2554/80; B60W 2556/10; B60W 2556/25; B60W 2556/50

(57) ABSTRACT

The present disclosure relates to an autonomous vehicle, a control system for sharing information therewith, and a method thereof. An exemplary embodiment of the present disclosure provides an autonomous vehicle, including: a communication device configured to transmit abnormal vehicle information to a control system and to receive analysis information of an abnormal vehicle from the control system; and an autonomous driving control apparatus including a processor that executes avoidance control logic based on the analysis information of the abnormal vehicle received from the control system during autonomous driving.

### CROSS-REFERENCE TO RELATED APPLICATION

This application claims priority to and benefits of Korean Patent Application No. 10-2021-0182764, filed in the Korean Intellectual Property Office on Dec. 20, 2021, the entire contents of which are incorporated herein by reference.

### TECHNICAL FIELD

The present disclosure relates to, a control system for sharing information therewith, and a method thereof, and more particularly, to a technique for controlling an autonomous vehicle to avoid abnormal vehicles around the autonomous vehicle based on abnormal vehicle information shared with the control system.

### BACKGROUND

As an electronic technique of a vehicle develops, an interest in an autonomous vehicle that drives to a destination by recognizing a driving environment of the vehicle itself without manipulation of a driver is growing more and more.

An autonomous vehicle refers to a vehicle capable of operating by itself without manipulation of a driver or an occupant.

While driving in an autonomous driving mode, when there is a vehicle that is driving abnormally or threateningly around the vehicle, it is avoided and controlled.

Conventionally, each autonomous vehicle detects an abnormal vehicle around a host vehicle thereof and avoids the detected abnormal vehicle, but when the host vehicle does not find the abnormal vehicle, it may be exposed to an accident risk.

The above information disclosed in this Background section is only for enhancement of understanding of the background of the disclosure, and therefore, it may contain information that does not form the prior art that is already known in this country to a person of ordinary skill in the art.

### SUMMARY

An exemplary embodiment of the present disclosure has been made in an effort to provide an autonomous vehicle, a control system for sharing information therewith, and a method thereof, capable of performing defensive driving against an abnormal vehicle by using abnormal vehicle information shared with the control system when the autonomous vehicle is autonomously driving, thereby improving commercialization of autonomous driving.

The technical objects of the present disclosure are not limited to the objects mentioned above, and other technical objects not mentioned can be clearly understood by those skilled in the art from the description of the claims.

An exemplary embodiment of the present disclosure provides an autonomous vehicle, including a communication device configured to transmit abnormal vehicle information to a control system and to receive analysis information of an abnormal vehicle from the control system; and an autonomous driving control apparatus including a processor that executes avoidance control logic based on the analysis information of the abnormal vehicle received from the control system during autonomous driving.

In an exemplary embodiment, the processor may download the analysis information of the abnormal vehicle from the control system when the autonomous driving is ended.

In an exemplary embodiment, the processor may download the analysis information of the abnormal vehicle from the control system every predetermined time or in real time during the autonomous driving.

In an exemplary embodiment, the processor may store the analysis information of the abnormal vehicle received from the control system.

In an exemplary embodiment, the processor may determine whether the abnormal vehicle exists among surrounding vehicles of the autonomous vehicle based on the stored analysis information of the abnormal vehicle when the autonomous driving starts.

In an exemplary embodiment, the autonomous vehicle may further include a sensing device that acquires information of the abnormal vehicle.

In an exemplary embodiment, the processor may determine whether or not the abnormal vehicle exists by comparing license plate information of the stored analysis information of the abnormal vehicle with license plate information of a surrounding vehicle acquired by the sensing device of the autonomous vehicle.

In an exemplary embodiment, the processor may encrypt the information of the abnormal vehicle acquired by the sensing device and transmit it to the control system.

In an exemplary embodiment, the processor, when it is determined that the abnormal vehicle exists among vehicles surrounding the autonomous vehicle based on the analysis information of the abnormal vehicle received from the control system, may execute the avoidance control logic to avoid the abnormal vehicle.

In an exemplary embodiment, the processor, when the abnormal vehicle does not exist among the vehicles surrounding the autonomous vehicle for a predetermined period, may delete previously stored analysis information of the abnormal vehicle.

In an exemplary embodiment, it may further include a storage configured to store the analysis information of the abnormal vehicle received from the control system.

In an exemplary embodiment, the processor may encrypt the analysis information of the abnormal vehicle to not display the analysis information.

In an exemplary embodiment, the processor may collect information related to surrounding vehicles from the sensing device while driving when an autonomous driving function is deactivated, and may collect the information related to the surrounding vehicles while driving and detects an abnormal vehicle based on the information related to the surrounding vehicles when the autonomous driving function is activated.

In an exemplary embodiment, the abnormal vehicle information may include at least one of abnormal vehicle position information, license plate information of the abnormal vehicle, pictures of the abnormal vehicle, whether avoidance control logic for avoiding the abnormal vehicle is activated, a time when the avoidance control logic is operated, or whether a horn sound information path is changed.

In an exemplary embodiment, the avoidance control logic may include increasing an inter-vehicle distance with the abnormal vehicle, or performing a lane change by checking whether the lane change is possible when the autonomous vehicle is in a same lane as that of the abnormal vehicle.

An exemplary embodiment of the present disclosure provides a control system including a communication device configured to communicate with an autonomous vehicle; and a processor configured to share analysis information of an abnormal vehicle obtained by analyzing a risk level of the abnormal vehicle based on abnormal vehicle information with autonomous vehicles when receiving the abnormal vehicle information from the autonomous vehicles.

In an exemplary embodiment, the processor may determine the risk level of the abnormal vehicle based on at least one of abnormal vehicle position information, license plate information of the abnormal vehicle, pictures of the abnormal vehicle, whether avoidance control logic for avoiding the abnormal vehicle is activated, a time when the avoidance control logic is operated, or whether a horn sound information path is changed.

In an exemplary embodiment, the processor may determine the risk level as a first level when there is no abnormal vehicle or no separate danger, may determine the risk level as a second level having a higher risk than the first level when abnormal driving of the abnormal vehicle affects a system of a host vehicle, may determine the risk level as a third level having a higher risk than the second level when avoidance control logic is activated or a horn sound is inputted to avoid the abnormal vehicle, and may determine the risk level as a fourth level having a higher level of risk than the third level when a global path is changed to avoid the abnormal vehicle.

An exemplary embodiment of the present disclosure provides a control method for an autonomous vehicle, including: collecting abnormal vehicle information while driving; encrypting the abnormal vehicle information and transmitting it to a control system; receiving analysis information of an abnormal vehicle collected from one or more autonomous vehicles from the control system; and executing avoidance control logic using the analysis information of the abnormal vehicle during autonomous driving.

In an exemplary embodiment, the receiving of the analysis information of the abnormal vehicle may include downloading the analysis information of the abnormal vehicle from the control system to store the analysis information when the autonomous driving is ended, and the executing of the avoidance control logic may include: determining whether the abnormal vehicle exists among surrounding vehicles of the autonomous vehicle based on the stored analysis information of the abnormal vehicle when the autonomous driving starts; and executing the avoidance control logic to avoid the abnormal vehicle when it is determined that the abnormal vehicle exists.

Accordingly, it is possible to perform defensive driving against an abnormal vehicle by using abnormal vehicle information shared with the control system when the autonomous vehicle is autonomously driving, thereby improving commercialization of autonomous driving.

In addition, various effects that can be directly or indirectly identified through this document may be provided.

### BRIEF DESCRIPTION OF THE DRAWINGS

FIG. 1 illustrates a block diagram showing a configuration of an autonomous apparatus system and a control system according to an exemplary embodiment of the present disclosure.

FIG. 2 illustrates a view for describing a function for each autonomous driving level of an autonomous vehicle according to an exemplary embodiment of the present disclosure.

FIG. 3 illustrates a table showing a risk level of an abnormal vehicle according to an exemplary embodiment of the present disclosure.

FIG. 4 illustrates a flowchart showing a method for controlling an autonomous vehicle to avoid an abnormal vehicle according to an exemplary embodiment of the present disclosure.

FIG. 5 illustrates a computing system according to an exemplary embodiment of the present disclosure.

### DETAILED DESCRIPTION OF THE EMBODIMENTS

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. In addition, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. In addition, all terms used herein including technical scientific terms have the same meanings as those which are generally understood by those skilled in the technical field to which the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

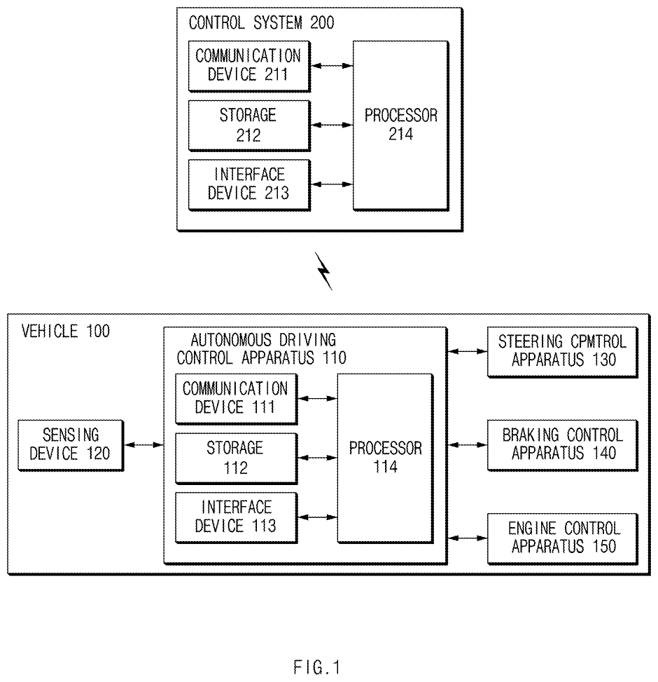

Hereinafter, exemplary embodiments of the present disclosure will be described in detail with reference to FIG. 1 to FIG. 5.

FIG. 1 illustrates a block diagram showing a configuration of an autonomous apparatus system and a control system according to an exemplary embodiment of the present disclosure.

Referring to FIG. 1, according to the exemplary embodiment of the present disclosure, the system may include a vehicle 100 and a control system 200, and abnormal vehicle information is shared through communication between the vehicle 100 and the control system 200. In this case, the vehicle 100 may include an autonomous vehicle.

The vehicle 100 may include an autonomous driving control apparatus 110, a sensing device 120, a steering control apparatus 130, a braking control apparatus 140, and an engine control apparatus 150.

The autonomous driving control apparatus 110 according to the exemplary embodiment of the present disclosure may be implemented inside the vehicle. In this case, the autonomous driving control apparatus 110 may be integrally formed with internal control units of the vehicle, or may be implemented as a separate device to be connected to control units of the vehicle by a separate connection means.

The autonomous driving control apparatus 110 collects abnormal vehicle information around it while driving and transmits it to the control system 200. In addition, the autonomous driving control apparatus 110 may download analysis information related to the abnormal vehicle collected from one or more autonomous vehicles from the control system 200 during autonomous driving, to execute avoidance control logic when there is a vehicle matching the abnormal vehicle information received from the control system 200 among vehicles around the host vehicle. In this case, the avoidance control logic may increase an inter-vehicle distance from the abnormal vehicle, or may include a lane change control.

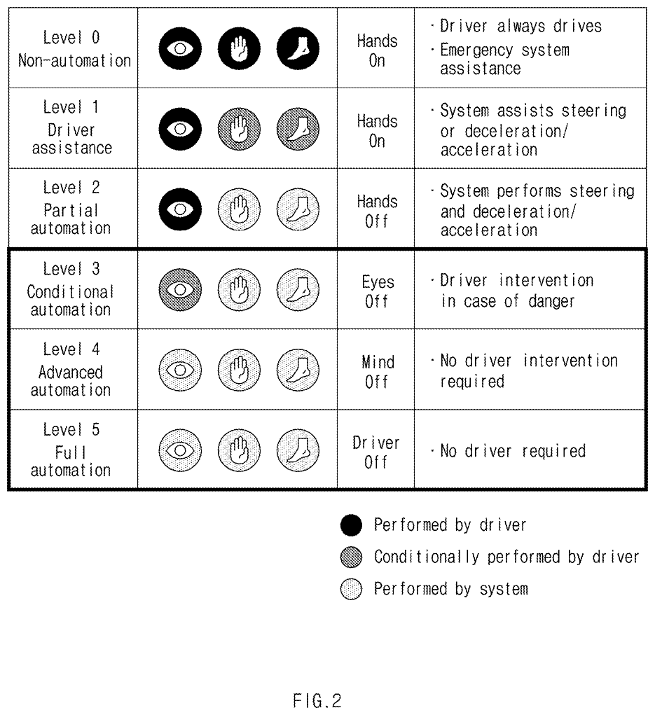

In addition, the autonomous driving control apparatus 110 may operate five autonomous driving function levels as illustrated in FIG. 2. FIG. 2 illustrates a view for describing a function for each autonomous driving level of an autonomous vehicle according to an exemplary embodiment of the present disclosure. Referring to FIG. 2, the autonomous driving function levels may be divided into Level 0, Level 1, Level 2, Level 3, Level 4, and Level 5. Level 0 indicates a non-automated state, in which a driver always drives. Level 1 indicates a driver assistance state, in which the autonomous driving control apparatus performs steering, deceleration, and acceleration assistance. Level 2 indicates a partially automated state, in which the autonomous driving control apparatus performs steering, deceleration, and acceleration. Level 3 indicates a conditionally automated state, in which the driver intervenes in case of danger during autonomous driving. Level 4 indicates advanced automated state, in which driver intervention is unnecessary during autonomous driving. Level 5 indicates a fully automated state, in which no driver is required.

According to the present disclosure, in the case of Level 3, Level 4, and Level 5, it is determined whether an abnormal vehicle exists in the vicinity during autonomous driving by receiving information of the abnormal vehicle from the control system 200, and when the abnormal vehicle exists, avoidance control may be performed.

The autonomous driving control apparatus 110 may include a communication device 111, a storage 112, an interface device 113, and a processor 114.

The communication device 111 is a hardware device implemented with various electronic circuits to transmit and receive signals through a wireless or wired connection, and may transmit and receive information based on in-vehicle devices and in-vehicle network communication techniques. As an example, the in-vehicle network communication techniques may include controller area network (CAN) communication, local interconnect network (LIN) communication, flex-ray communication, Ethernet communication, and the like.

In addition, the communication device 111 may perform communication by using a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, world Interoperability for microwave access (Wimax), Ethernet communication, etc. In addition, short-range communication technique may include bluetooth, ZigBee, ultra wideband (UWB), radio frequency identification (RFID), infrared data association (IrDA), and the like. For example, the communication device 111 may perform wireless communication with the control system 200, may transmit vehicle position information (e.g., vehicle coordinates), surrounding information (e.g., abnormal vehicle information (abnormal vehicle position, abnormal driving license plate information, driving pattern of abnormal vehicle, vehicle speed of abnormal vehicle, etc.), etc. to the control system 200, and may receive analysis information related to the abnormal vehicle collected from other vehicles, and the like from the control system 200.

The storage 112 may store sensing results of the sensing device 120, information received from the control system 200, data and/or algorithms required for the processor 114 to operate, and the like.

As an example, the storage 112 may store abnormal vehicle information sensed by the sensing device 120 and abnormal vehicle analysis information received from the control system 200. In this case, the abnormal vehicle information includes at least one of abnormal vehicle position information, license plate information of the abnormal vehicle, pictures of the abnormal vehicle, whether avoidance control logic for avoiding the abnormal vehicle is activated, a time when the avoidance control logic is operated, or whether a horn sound information path is changed. In addition, the abnormal vehicle analysis information may include license plate information of the abnormal vehicle, risk level information of the abnormal vehicle, and the like.

The storage 112 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 113 may include an input means for receiving a control command from a user and an output means for outputting an operation state of the autonomous driving control apparatus 110 and results thereof. Herein, the input means may include a key button, and may further include a mouse, a keyboard, a touch screen, a microphone, a joystick, a jog shuttle, a stylus pen, and the like. In addition, the input means may further include a soft key implemented on the display.

The output means may include a display, and may further include a voice output means such as a speaker. In this case, when a touch sensor formed of a touch film, a touch sheet, or a touch pad is provided on the display, the display may operate as a touch screen, and may be implemented in a form in which an input device and an output device are integrated.

In this case, the display may include at least one of a liquid crystal display (LCD), a thin film transistor liquid crystal display (TFT LCD), an organic light emitting diode display (OLED display), a flexible display, a field emission display (FED), or a 3D display.

As an example, the interface device 113 may be implemented as a head-up display (HUD), a cluster, an audio video navigation (AVN), a human machine interface (HM), a user setting menu (USM), or the like.

For example, the interface device 113 may display a request phrase such as transfer of control authority during autonomous driving, and may receive an approval for the transfer of control authority from a driver, etc. To this end, the interface device 113 may receive the input from the driver through a mouse, a keyboard, a touch screen, a microphone, or the like.

The processor 114 may be electrically connected to the communication device 111, the storage 112, the interface device 113, and the like, may electrically control each component, and may be an electrical circuit that executes software commands, thereby performing various data processing and calculations described below.

The processor 114 may process a signal transferred between components of the autonomous driving control apparatus 110, and may perform overall control such that each of the components can perform its function normally.

The processor 114 may be implemented in the form of hardware, software, or a combination of hardware and software, or may be implemented as microprocessor, and may be, e.g., an electronic control unit (ECU), a micro controller unit (MCU), or other subcontrollers mounted in the vehicle.

The processor 114 may perform the avoidance control logic using the analysis information of the abnormal vehicle received from the control system 200 during autonomous driving.

The processor 114 may download analysis information of the abnormal vehicle from the control system 200 when the autonomous driving ends, or may download the analysis information of the abnormal vehicle from the control system 200 at a predetermined time or in real time during autonomous driving to store it in the storage 112.

When autonomous driving starts, the processor 114 may determine whether an abnormal vehicle exists among surrounding vehicles of a host vehicle by using the stored analysis information of the abnormal vehicle.

That is, the processor 114 may determine whether or not the abnormal vehicle exists by comparing license plate information of the stored abnormal vehicle analysis information with license plate information of a surrounding vehicle acquired by a sensing device of the host vehicle.

The processor 114 encrypts and transmits the abnormal vehicle information obtained by the sensing device to the control system 200, and may also encrypt analysis information of the abnormal vehicle received from the control system 200 so that the driver cannot know the abnormal vehicle information, thereby protecting personal information.

When it is determined that there is an abnormal vehicle among the vehicles surrounding the host vehicle based on the analysis information of the abnormal vehicle received from the control system 200, the processor 114 may control the host vehicle to avoid the abnormal vehicle.

That is, the processor 114 may perform a lane change by increasing an inter-vehicle distance with the abnormal vehicle or by checking whether the lane change is possible when the host vehicle is in a same lane as that of the abnormal vehicle.

When there is no abnormal vehicle among the vehicles surrounding the host vehicle for a predetermined period, the processor 114 may protect personal information by deleting pre-stored analysis information of the abnormal vehicle.

The processor 114 may collect information related to surrounding vehicles using the sensing device 120 while driving when the autonomous driving function is deactivated, and may collect information related to surrounding vehicles while driving and may detect an abnormal vehicle based on the information related to the surrounding vehicles when the autonomous driving function is activated.

The sensing device 120 may include one or more sensors that sense an obstacle, e.g., a surrounding vehicle, positioned around the host vehicle and measure a distance with the obstacle and/or a relative speed thereof.

The sensing device 120 may include a plurality of sensors to sense an external object of the vehicle, to obtain information related to a position of the external object, a speed of the external object, a moving direction of the external object, and/or a type of the external object (e.g., vehicles, pedestrians, bicycles or motorcycles, etc.). To this end, the sensing device 120 may include an ultrasonic sensor, a radar, a camera, a laser scanner, and/or a corner radar, a lidar, an acceleration sensor, a yaw rate sensor, a torque measurement sensor and/or a wheel speed sensor, a steering angle sensor, etc.

The steering control device 130 may be configured to control a steering angle of a vehicle, and may include a steering wheel, an actuator interlocked with the steering wheel, and a controller controlling the actuator.

The braking control device 140 may be configured to control braking of the vehicle, and may include a controller that controls a brake thereof.

The engine control device 150 may be configured to control engine driving of a vehicle, and may include a controller that controls a speed of the vehicle.

The control system 200 may receive abnormal vehicle information from one or more autonomous vehicles, may analyze and store the risk level, and then may share collected abnormal vehicle information with the autonomous vehicles.

The control system 200 may include a communication device 211, a storage 212, an interface device 213, and a processor 214.

The communication device 211 is a hardware device implemented with various electronic circuits to transmit and receive signals through a wireless or wired connection, and may transmit and receive information based on in-vehicle devices and in-vehicle network communication techniques. As an example, the in-vehicle network communication techniques may include controller area network (CAN) communication, local interconnect network (LIN) communication, flex-ray communication, Ethernet communication, and the like.

In addition, the communication device 211 may perform communication by using a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, world Interoperability for microwave access (Wimax), etc. In addition, short-range communication technique may include bluetooth, ZigBee, ultra wideband (UWB), radio frequency identification (RFID), infrared data association (IrDA), and the like. For example, the communication device 211 may perform wireless communication with the vehicle 100, may receive abnormal vehicle information from the vehicle 100, and may transmit analysis information (e.g., risk level information, license plate information of the abnormal vehicle, etc.) related to the abnormal vehicle collected from one or more vehicles to the vehicle 100. The storage 212 may store information received from the vehicle 100, and data and/or algorithm required for the processor 214 to operate, and the like. As an example, the storage 212 may store abnormal vehicle information received from the vehicle 100 and analysis information such as a risk level for each abnormal vehicle analyzed by the processor 214.

The storage 212 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 213 may include an input means capable of receiving a control command from an operator and an output means for outputting an operation state of the control system 200 and results thereof. Herein, the input means may include a key button, and may further include a mouse, a keyboard, a touch screen, a microphone, a joystick, a jog shuttle, a stylus pen, and the like. In addition, the input means may further include a soft key implemented on the display. For example, the interface device 213 may further include all communication terminals such as a personal computer (PC), a notebook computer, a smartphone, a tablet PC, a pad, a personal digital assistant (PDA), and a wearable device.

The output means may include a display, and may further include a voice output means such as a speaker. In this case, when a touch sensor formed of a touch film, a touch sheet, or a touch pad is provided on the display, the display may operate as a touch screen, and may be implemented in a form in which an input device and an output device are integrated.

In this case, the display may include at least one of a liquid crystal display (LCD), a thin film transistor liquid crystal display (TFT LCD), an organic light emitting diode display (OLED display), a flexible display, a field emission display (FED), or a 3D display.

The processor 214 may be electrically connected to the communication device 211, the storage 212, the interface device 213, and the like, may electrically control each component, and may be an electrical circuit that executes software commands, thereby performing various data processing and calculations described below.

The processor 214 may process a signal transferred between components of the control system 200, and may perform overall control such that each of the components can perform its function normally. The processor 214 may be implemented in the form of hardware, software, or a combination of hardware and software, or may be implemented as microprocessor.

When receiving abnormal vehicle information from autonomous vehicles, the processor 214 may share analysis information of the abnormal vehicle obtained by analyzing the risk level of the abnormal vehicle using the abnormal vehicle information with the autonomous vehicles.

The processor 214 may determine the risk level of the abnormal vehicle by using at least one of abnormal vehicle position information, license plate information of the abnormal vehicle, pictures of the abnormal vehicle, whether avoidance control logic for avoiding the abnormal vehicle is activated, a time when the avoidance control logic is operated, or whether a horn sound information path is changed.

That is, the processor 214 may determine the risk level as a first level when there is no abnormal vehicle or no separate risk, may determine the risk level as a second level having a higher risk than the first level when abnormal driving of the abnormal vehicle affects the system of the host vehicle, may determine the risk level as a third level having a higher risk than the second level when the avoidance control logic is activated or a horn sound is inputted to avoid the abnormal vehicle, and may determine the risk level as a fourth level having a higher level of risk than the third level when a global path is changed to avoid an abnormal vehicle.

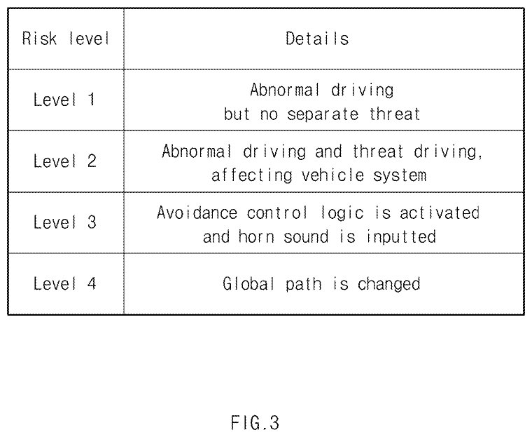

The risk level of the abnormal vehicle is illustrated in FIG. 3. FIG. 3 illustrates a table showing a risk level of an abnormal vehicle according to an exemplary embodiment of the present disclosure. Referring to FIG. 3, Risk level 1 indicates a state in which it is recognized as specific driving, but there is no separate threat. Risk level 2 indicates a state in which it is recognized as specific driving and threat driving, affecting a vehicle system. Risk level 3 indicates a state in which avoidance control logic is activated and a horn sound is inputted. Risk level 4 indicates a state in which a global path is changed.

When receiving a request for downloading analysis information related to the abnormal vehicle from the vehicle 100, the processor 214 may transmit, to the vehicle 100, analysis information related to the abnormal vehicle detected within a predetermined distance from a current position of the vehicle 100.

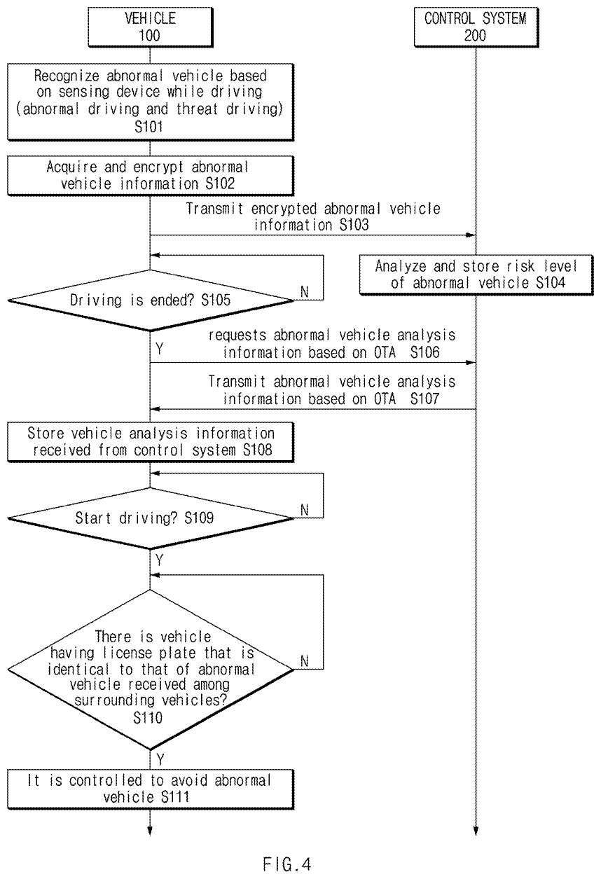

Hereinafter, a method for controlling an abnormal vehicle to avoid an abnormal vehicle according to an exemplary embodiment of the present disclosure will be described in detail with reference to FIG. 4. FIG. 4 illustrates a flowchart showing a method for controlling an autonomous vehicle to avoid an abnormal vehicle according to an exemplary embodiment of the present disclosure.

Hereinafter, it is assumed that the autonomous driving control apparatus 110 of the vehicle 100 of FIG. 1 and the control system 200 perform processes of FIG. 4. In addition, in the description of FIG. 4, it may be understood that operations described as being performed by each system are controlled by a processor of each of the systems.

Referring to FIG. 4, the vehicle 100 recognizes an abnormal vehicle based on the sensing device 120 while driving (S101). In this case, the abnormal vehicle may include a vehicle that crosses a lane and threatens the host vehicle, a vehicle that repeatedly accelerates or stops suddenly, a vehicle that moves between lanes, a vehicle that drives recklessly, and the like. In this case, the vehicle 100 may recognize the abnormal vehicle while an autonomous driving control function is activated by a driver. In addition, the vehicle 100 may collect information even in a state in which the autonomous driving control function is not activated.

The vehicle 100 acquires abnormal vehicle information and encrypts the abnormal vehicle information (S102).

The abnormal vehicle information may include abnormal vehicle position information, license plate information of the abnormal vehicle, pictures of the abnormal vehicle, a time for which the autonomous driving control apparatus recognizes the abnormal vehicle and activates an actual avoidance mode, whether avoidance logic is activated, a horn sound, whether to change a path, etc.

The vehicle 100 transmits the encrypted abnormal vehicle information to the control system 200 (S103). In this case, the vehicle 100 may transmit information (e.g., vehicle position information, etc.) of the host vehicle to the control system 200 together.

Accordingly, the control system 200 analyzes and stores a risk level of the abnormal vehicle based on the abnormal vehicle information (S104). The risk level may be determined depending on whether it is possible to handle it using an avoidance logic operation, whether a global path change step is activated, whether a horn is inputted, and the like.

At an end of autonomous driving (S105), the vehicle 100 requests abnormal vehicle analysis information to the control system 200 based on OTA (On The Air).

Accordingly, the control system 200 transmits, to the vehicle 100, the abnormal vehicle analysis information of abnormal vehicles collected from one or more vehicles. In this case, the abnormal vehicle information includes abnormal driving license plate information and risk level information. In addition, the control system 200 may transmit only analysis information of an abnormal vehicle that was positioned within a predetermined distance from a position of the vehicle 100 that requested the abnormal vehicle analysis information to the vehicle 100. In addition, the control system 200 may list up it depending on the risk level of the abnormal vehicle, and may transmit it to the vehicle 100. In addition, the control system 200 may transmit analysis information of a predetermined number of abnormal vehicles with a high risk to the vehicle 100.

Accordingly, the vehicle 100 stores vehicle analysis information received from the control system 200 (S108). In this case, FIG. 4 illustrates an example in which the vehicle 100 requests the control system 200 to download and use abnormal vehicle analysis information based on OTA, but the present disclosure is not limited thereto, and the control system 200 may broadcast abnormal vehicle analysis information to autonomous vehicles in real time after risk analysis.

Thereafter, when the vehicle 100 starts autonomous driving (S109), it is determined whether information obtained by sensing surrounding vehicles while driving is consistent with the abnormal vehicle analysis information received from the control system 200 through comparison (S110). That is, the vehicle 100 compares license plates of the surrounding vehicles sensed by the sensing device 120 of the host vehicle with a license plate of the abnormal vehicle received from the control system 200 to determine whether they match.

Then, when they match, the vehicle 100 is controlled to avoid the abnormal vehicle (S111). In this case, the vehicle 100 may not display the abnormal vehicle information during autonomous driving, thereby protecting personal information related to a driver of the abnormal vehicle.

In addition, the vehicle 100 may delete the abnormal vehicle analysis information when no abnormal vehicle is detected among surrounding vehicles for a predetermined period.

As such, the control system 200 of the present disclosure may collect abnormal vehicle information from autonomous vehicles to analyze risk degrees for each of the abnormal vehicles, and may share risk analysis information related to an abnormal vehicle with the autonomous vehicles, so that each of the autonomous vehicles acquires information related to an surrounding abnormal vehicle that is not detected only by a sensing device of the host vehicle in advance, to ensure safety of the driver, thereby improving marketability of the autonomous driving system.

In addition, it is possible to the present disclosure, it is possible to maximize an effect by linking the autonomous driving system and a black box mounted on a vehicle, and in particular, when applied to service vehicles such as a robo-taxi, the effect may be maximized.

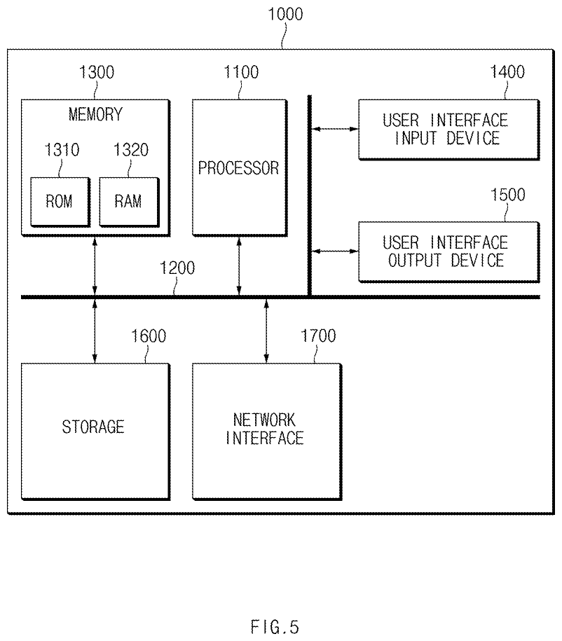

FIG. 5 illustrates a computing system according to an exemplary embodiment of the present disclosure.

Referring to FIG. 5, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. An autonomous vehicle comprising:
a communication device configured to transmit abnormal vehicle information to a control system and to receive analysis information of an abnormal vehicle from the control system; and
an autonomous driving control apparatus including a processor that executes avoidance control logic based on the analysis information of the abnormal vehicle received from the control system during autonomous driving.

2. The autonomous vehicle of claim 1, wherein
the processor
downloads the analysis information of the abnormal vehicle from the control system when the autonomous driving is ended.

3. The autonomous vehicle of claim 1, wherein
the processor
downloads the analysis information of the abnormal vehicle from the control system every predetermined time or in real time during the autonomous driving.

4. The autonomous vehicle of claim 1, wherein
the processor
stores the analysis information of the abnormal vehicle received from the control system.

5. The autonomous vehicle of claim 4, wherein
the processor
determines whether the abnormal vehicle exists among surrounding vehicles of the autonomous vehicle based on the stored analysis information of the abnormal vehicle when the autonomous driving starts.

6. The autonomous vehicle of claim 5, further comprising a sensing device that acquires information of the abnormal vehicle.

7. The autonomous vehicle of claim 6, wherein
the processor
determines whether or not the abnormal vehicle exists by comparing license plate information of the stored analysis information of the abnormal vehicle with license plate information of a surrounding vehicle acquired by the sensing device of the autonomous vehicle.

8. The autonomous vehicle of claim 6, wherein
the processor
encrypts the information of the abnormal vehicle acquired by the sensing device and transmits it to the control system.

9. The autonomous vehicle of claim 1, wherein
the processor,
when it is determined that the abnormal vehicle exists among vehicles surrounding the autonomous vehicle based on the analysis information of the abnormal vehicle received from the control system,
executes the avoidance control logic to avoid the abnormal vehicle.

10. The autonomous vehicle of claim 9, wherein
the processor,
when the abnormal vehicle does not exist among the vehicles surrounding the autonomous vehicle for a predetermined period,
deletes previously stored analysis information of the abnormal vehicle.

11. The autonomous vehicle of claim 1, further comprising
a storage configured to store the analysis information of the abnormal vehicle received from the control system.

12. The autonomous vehicle of claim 1, wherein
the processor,
encrypts the analysis information of the abnormal vehicle to not display the analysis information.

13. The autonomous vehicle of claim 6, wherein
the processor
collects information related to surrounding vehicles from the sensing device while driving when an autonomous driving function is deactivated, and
collects the information related to the surrounding vehicles while driving and detects an abnormal vehicle based on the information related to the surrounding vehicles when the autonomous driving function is activated.

14. The autonomous vehicle of claim 1, wherein
the abnormal vehicle information includes
at least one of abnormal vehicle position information, license plate information of the abnormal vehicle, pictures of the abnormal vehicle, whether avoidance control logic for avoiding the abnormal vehicle is activated, a time when the avoidance control logic is operated, or whether a horn sound information path is changed.

15. The autonomous vehicle of claim 1, wherein
the avoidance control logic includes
increasing an inter-vehicle distance with the abnormal vehicle, or
performing a lane change by checking whether the lane change is possible when the autonomous vehicle is in a same lane as that of the abnormal vehicle.

16. A control system comprising:
a communication device configured to communicate with an autonomous vehicle; and
a processor configured to share analysis information of an abnormal vehicle obtained by analyzing a risk level of the abnormal vehicle based on abnormal vehicle information with autonomous vehicles when receiving the abnormal vehicle information from the autonomous vehicles.

17. The control system of claim 16, wherein
the processor
determines the risk level of the abnormal vehicle based on at least one of abnormal vehicle position information, license plate information of the abnormal vehicle, pictures of the abnormal vehicle, whether avoidance control logic for avoiding the abnormal vehicle is activated, a time when the avoidance control logic is operated, or whether a horn sound information path is changed.

18. The control system of claim 16, wherein
the processor
determines the risk level as a first level when there is no abnormal vehicle or no separate danger,
determines the risk level as a second level having a higher risk than the first level when abnormal driving of the abnormal vehicle affects a system of a host vehicle,
determines the risk level as a third level having a higher risk than the second level when avoidance control logic is activated or a horn sound is inputted to avoid the abnormal vehicle, and
determines the risk level as a fourth level having a higher level of risk than the third level when a global path is changed to avoid the abnormal vehicle.

19. A control method for an autonomous vehicle, comprising:
collecting abnormal vehicle information while driving;
encrypting the abnormal vehicle information and transmitting it to a control system;
receiving analysis information of an abnormal vehicle collected from one or more autonomous vehicles from the control system; and
executing avoidance control logic using the analysis information of the abnormal vehicle during autonomous driving.

20. The control method of claim 19, wherein
the receiving of the analysis information of the abnormal vehicle includes
downloading the analysis information of the abnormal vehicle from the control system to store the analysis information when the autonomous driving is ended, and
the executing of the avoidance control logic includes:
determining whether the abnormal vehicle exists among surrounding vehicles of the autonomous vehicle based on the stored analysis information of the abnormal vehicle when the autonomous driving starts; and
executing the avoidance control logic to avoid the abnormal vehicle when it is determined that the abnormal vehicle exists.
